(19) United States
(12) Patent Application Publication
(10) Pub. No.: US 2026/0162864 A1
(43) Pub. Date: Jun. 11, 2026

(54) COIL DEVICE AND ACTUATOR

(71) Applicant: SUMITOMO ELECTRIC PRINTED CIRCUITS, INC., Shiga (JP)

(72) Inventor: Michi OGATA, Shiga (JP)

(73) Assignee: SUMITOMO ELECTRIC PRINTED CIRCUITS, INC., Shiga (JP)

(21) Appl. No.: 19/410,311

(22) Filed: Dec. 5, 2025

(30) Foreign Application Priority Data
Dec. 9, 2024 (JP) 2024-214205

(51) Int. Cl. H01F 7/18; H01F 7/06

(52) U.S. Cl. CPC H01F 7/18; H01F 2007/068

(57) ABSTRACT

A coil device includes a first printed wiring board and a second printed wiring board. The first printed wiring board include a first base film having a first main surface, and a first wire disposed on the first main surface. The first wire includes a plurality of first coil portions each formed by winding the first wire spirally in a plan view, the plurality of first coil portions being arranged along a circumferential direction. The second printed wiring board includes a second base film having a second main surface and a third main surface, and a second wire disposed on the second main surface. The third main surface faces the first main surface. The second wire includes a plurality of second coil portions each formed by winding the second wire spirally in plan view, the plurality of second coil portions being arranged along the circumferential direction.

### CROSS REFERENCE TO RELATED APPLICATIONS

This application claims priority based on Japanese Patent Application No. 2024-214205 filed on Dec. 9, 2024, the entire contents of which are incorporated herein by reference.

### TECHNICAL FIELD

The present disclosure relates to a coil device and an actuator.

### BACKGROUND

Japanese Unexamined Patent Application Publication No. 2024-71959 (Patent Literature 1) describes an axial gap motor. The axial gap motor described in Patent Literature 1 includes a coil device and a magnet. The coil device includes a substrate and a plurality of wound-wire coils disposed on the substrate. The plurality of wound-wire coils are arranged in an annular shape along a circumferential direction in plan view. A torque that rotates the coil device in the circumferential direction is generated in the plurality of wound-wire coils by an interaction between a magnetic field generated by the magnet and current flowing through the wound-wire coils.

### SUMMARY

A coil device according to the present disclosure includes a first printed wiring board and a second printed wiring board. The first printed wiring board includes a first base film having a first main surface, and a first wire disposed on the first main surface. The first wire includes a plurality of first coil portions each formed by winding the first wire spirally in plan view, the plurality of first coil portions being arranged along a circumferential direction. The second printed wiring board includes a second base film having a second main surface and a third main surface, and a second wire disposed on the second main surface. The third main surface faces the first main surface. The second wire includes a plurality of second coil portions each formed by winding the second wire spirally in plan view, the plurality of second coil portions being arranged along the circumferential direction. The second printed wiring board is offset in the circumferential direction with respect to the first printed wiring board such that one second coil portion among the plurality of second coil portions overlaps, in plan view, two adjacent first coil portions among the plurality of first coil portions.

### BRIEF DESCRIPTION OF THE DRAWINGS

FIG. 1 is a first plan view of a coil device 100.

FIG. 2 is a second plan view of the coil device 100.

FIG. 3 is a third plan view of the coil device 100.

FIG. 4 is a fourth plan view of the coil device 100.

FIG. 5 is a cross-sectional view taken along line V-V in FIG. 3.

FIG. 6 is a cross-sectional view taken along line VI-VI in FIG. 3.

FIG. 7 is a first cross-sectional view illustrating an operation of the coil device 100.

FIG. 8 is a second cross-sectional view illustrating the operation of the coil device 100.

FIG. 9 is a graph showing a torque applied to a plurality of coil portions 33 and a plurality of coil portions 43 in the coil device according to a comparative example.

FIG. 10 is a graph showing a torque applied to the plurality of coil portions 33 and the plurality of coil portions 43 in the coil device according to the comparative example when power supply control is performed.

FIG. 11 is a graph showing a torque applied to a plurality of coil portions 33 and a plurality of coil portions 43 in the coil device 100.

FIG. 12 is a graph showing a torque applied to the plurality of coil portions 33 and the plurality of coil portions 43 in the coil device 100 when power supply control is performed.

FIG. 13 is a graph showing a resultant torque applied to the coil device 100 when the power supply control is performed.

### DETAILED DESCRIPTION

In the coil device included in the axial gap motor described in Patent Literature 1, the torque that rotates the coil device in a circumferential direction greatly fluctuates with a rotation phase. The present disclosure has been made in view of the problem of conventional technology as described above. More specifically, the present disclosure provides a coil device in which a fluctuation of a torque with a rotation phase can be suppressed.

### Description of Embodiments of Present Disclosure

First, embodiments of the present disclosure will be listed and described.

(1) A coil device according to an embodiment includes a first printed wiring board and a second printed wiring board. The first printed wiring board includes a first base film having a first main surface, and a first wire disposed on the first main surface. The first wire includes a plurality of first coil portions each formed by winding the first wire spirally in plan view, the plurality of first coil portions being arranged along a circumferential direction. The second printed wiring board includes a second base film having a second main surface and a third main surface, and a second wire disposed on the second main surface. The third main surface faces the first main surface. The second wire includes a plurality of second coil portions each formed by winding the second wire spirally in plan view, the plurality of second coil portions being arranged along the circumferential direction. The second printed wiring board is offset in the circumferential direction with respect to the first printed wiring board such that one second coil portion among the plurality of second coil portions overlaps, in plan view, two adjacent first coil portions among the plurality of first coil portions. According to the coil device in the above (1), a fluctuation of a torque with a rotation phase can be suppressed.

(2) In the coil device of the above (1), each of the plurality of first coil portions may include a first portion and a second portion each extending along the circumferential direction in plan view, the first portion and the second portion being arranged along a radial direction perpendicular to the circumferential direction to be spaced apart from each other. Each of the plurality of second coil portions may include a third portion and a fourth portion each extending along the radial direction in plan view, the third portion and the fourth portion being arranged along the circumferential direction to be spaced apart from each other. The second printed wiring board may be offset in the circumferential direction with respect to the first printed wiring board such that the third portion of the one second coil portion overlaps, in plan view, the first portion and the second portion of one of the two adjacent first coil portions and such that the fourth portion of the one second coil portion overlaps, in plan view, the first portion and the second portion of another one of the two adjacent first coil portions. According to the coil device in the above (2), the fluctuation of the torque with the rotation phase can be further suppressed.

(3) In the coil device according to the above (1) or (2), the first base film may have a fourth main surface. The first printed wiring board may further include a third wire disposed on the fourth main surface. The third wire may include a plurality of third coil portions each formed by winding the third wire spirally in plan view, the plurality of third coil portions being arranged along the circumferential direction. The plurality of third coil portions may overlap, in plan view, the plurality of first coil portions respectively. The second printed wiring board may further include a fourth wire disposed on the third main surface. The fourth wire may include a plurality of fourth coil portions each formed by winding the fourth wire spirally in plan view, the plurality of fourth coil portions being arranged along the circumferential direction. The plurality of fourth coil portions may overlap, in plan view, the plurality of second coil portions respectively.

(4) A coil device according to another embodiment includes a printed wiring board. The printed wiring board includes a base film having a first main surface and a second main surface, a first wire disposed on the first main surface, and a second wire disposed on the second main surface. The first wire includes a plurality of first coil portions each formed by winding the first wire spirally in a plan view, the plurality of first coil portions being arranged along a circumferential direction. The second wire includes a plurality of second coil portions each formed by winding the second wire spirally in plan view, the plurality of second coil portions being arranged along the circumferential direction. In plan view, one second coil portion among the plurality of second coil portions is offset in the circumferential direction to overlap two adjacent first coil portions among the plurality of first coil portions. According to the coil device in the above (4), the fluctuation of the torque with the rotation phase can be suppressed.

(5) An actuator according to an embodiment includes the coil device in any one of the above (1) to (4), and a magnet that generates a magnetic field along a normal direction of each of the first and second main surfaces. According to the actuator in the above (5), the fluctuation of the torque with the rotation phase can be further suppressed in the coil device.

### Details of Embodiments of Present Disclosure

The details of embodiments according to the present disclosure will be described below with reference to the drawings. In the following drawings, the same or corresponding parts are denoted by the same reference numerals, and redundant description thereof will be omitted. A coil device according to the embodiment is referred to as a coil device 100.

### (Configuration of Coil Device 100)

The configuration of the coil device 100 will be described below.

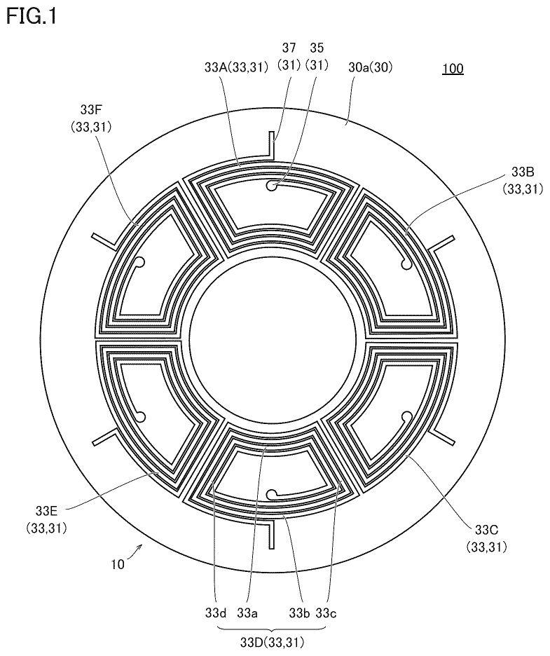

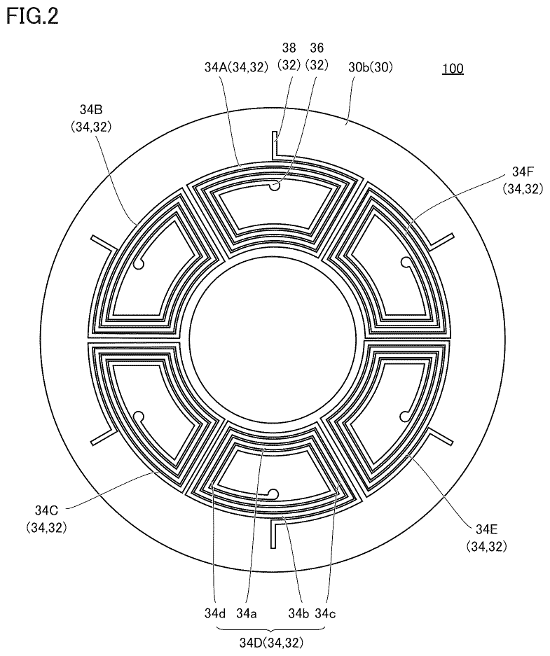

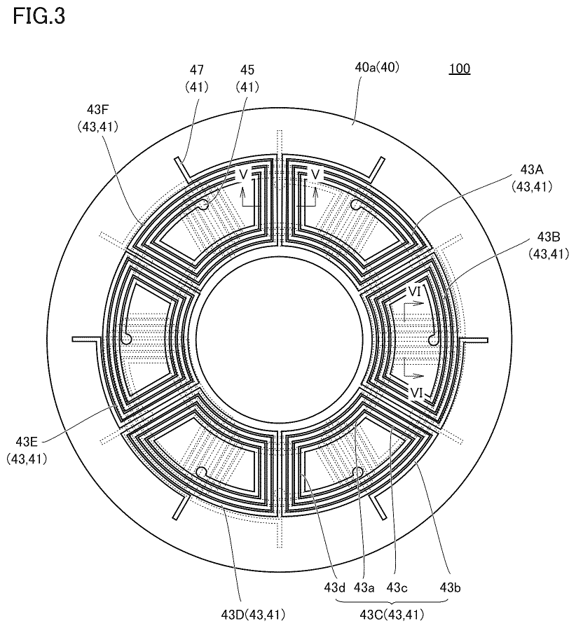

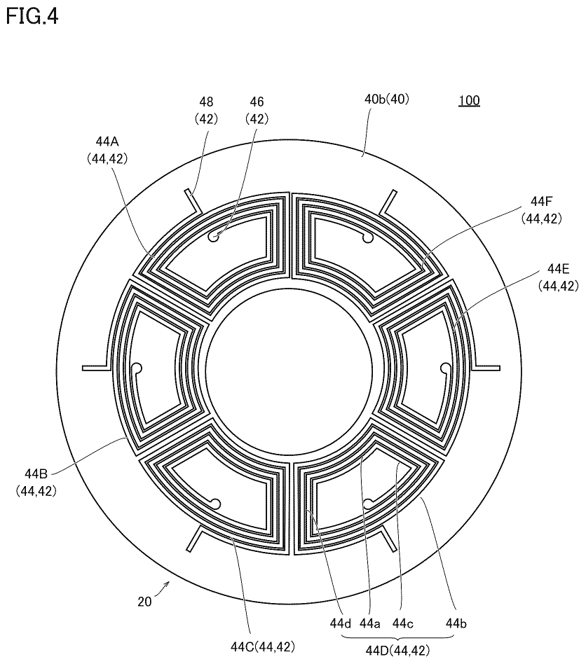

FIG. 1 is a first plan view of the coil device 100. FIG. 2 is a second plan view of the coil device 100. FIG. 3 is a third plan view of the coil device 100. FIG. 4 is a fourth plan view of the coil device 100. In FIG. 1, a printed wiring board 20 is not shown. In FIG. 4, a printed wiring board 10 is not shown. FIG. 2 and FIG. 4 are plan views of sides of the coil device 100 opposite to the sides shown in FIG. 1 and FIG. 2, respectively. As shown in FIG. 1 to FIG. 4, the coil device 100 includes the printed wiring board 10 and the printed wiring board 20.

The printed wiring board 10 includes a base film 30, a wire 31, and a wire 32. The base film 30 has a main surface 30a and a main surface 30b. The main surface 30b is a surface opposite to the main surface 30a. The main surface 30a and the main surface 30b are end surfaces of the base film 30 in a thickness direction. The base film 30 is formed of an electrically insulating material having flexibility. The base film 30 is formed of, for example, polyimide.

The wire 31 is disposed on the main surface 30a. The wire 31 includes the plurality of coil portions 33. The plurality of coil portions 33 are arranged in an annular shape in plan view. A direction in which the plurality of coil portions 33 are arranged may be referred to as a circumferential direction DR1. A direction perpendicular to the circumferential direction DR1 may be referred to as a radial direction DR2. In the example shown, the wire 31 includes six coil portions 33. These six coil portions 33 are respectively referred to as a coil portion 33A, a coil portion 33B, a coil portion 33C, a coil portion 33D, a coil portion 33E, and a coil portion 33F. The coil portion 33A, the coil portion 33B, the coil portion 33C, the coil portion 33D, the coil portion 33E, and the coil portion 33F are arranged in this order in a clockwise direction when viewed from the main surface 30a side. The coil portions 33 are each formed by winding the wire 31 spirally in plan view. A winding direction of the wire 31 in one of two adjacent coil portions 33 is opposite to a winding direction of the wire 31 in the other of the two adjacent coil portions 33.

Each of the coil portions 33 includes a first portion 33a, a second portion 33b, a third portion 33c, and a fourth portion 33d. The first portion 33a and the second portion 33b each extend along the circumferential direction DR1 in plan view, and are spaced apart from each other along the radial direction DR2 in plan view. The third portion 33c and the fourth portion 33d each extend along the radial direction DR2 in plan view, and are spaced apart from each other along the circumferential direction DR1 in plan view.

The wire 32 is disposed on the main surface 30b. The wire 32 includes a plurality of coil portions 34. The plurality of coil portions 34 are arranged in an annular shape along the circumferential direction in plan view. In the example shown, the wire 32 includes six coil portions 34. These six coil portions 34 are respectively referred to as a coil portion 34A, a coil portion 34B, a coil portion 34C, a coil portion 34D, a coil portion 34E, and a coil portion 34F. The coil portion 34A, the coil portion 34B, the coil portion 34C, the coil portion 34D, the coil portion 34E, and the coil portion 34F are arranged in this order in a counterclockwise direction when viewed from the main surface 30b side.

The coil portions 34 are each formed by winding the wire 32 spirally in plan view. A winding direction of the wire 32 in one of two adjacent coil portions 34 is opposite to a winding direction of the wire 32 in the other of the two adjacent coil portions 34. Each of the coil portions 34 includes a first portion 34a and a second portion 34b that each extend along the circumferential direction DR1 in plan view and are spaced apart from each other along the radial direction DR2 in plan view, and a third portion 34c and a fourth portion 34d that each extend along the radial direction DR2 in plan view and are spaced apart from each other along the circumferential direction DR1 in plan view.

The plurality of coil portions 34 overlaps, in plan view, the plurality of coil portions 33 respectively. More specifically, the coil portion 34A, the coil portion 34B, the coil portion 34C, the coil portion 34D, the coil portion 34E, and the coil portion 34F overlap, in plan view, the coil portion 33A, the coil portion 33B, the coil portion 33C, the coil portion 33D, the coil portion 33E, and the coil portion 33F, respectively. Each of the plurality of coil portions 34 overlaps, in plan view, only one coil portion 33 among the plurality of coil portions 33, and does not overlap, in plan view, any other coil portions 33. In plan view, the first portion 34a and the second portion 34b overlap the first portion 33a and the second portion 33b, respectively, and the third portion 34c and the fourth portion 34d overlap the third portion 33c and the fourth portion 33d, respectively.

The wire 31 further includes a plurality of lands 35. The plurality of lands 35 are connected to the innermost peripheral portions of the plurality of coil portions 33 respectively. The wire 32 further includes a plurality of lands 36. The plurality of lands 36 are connected to the innermost peripheral portions of the plurality of coil portions 34 respectively. The plurality of lands 36 overlap, in plan view, the plurality of lands 35 respectively and are electrically connected to the plurality of lands 35 respectively.

The wire 31 further includes a plurality of connecting portions 37. The plurality of connecting portions 37 are connected to the outermost peripheral portions of the plurality of coil portions 33 respectively. The wire 32 further includes a plurality of connecting portions 38. The plurality of connecting portions 38 are connected to the outermost peripheral portions of the coil portions 34 respectively.

One connecting portion 37 among the plurality of connecting portions 37 is connected to the coil portion 33A and is electrically connected to a power supply terminal (not shown). One connecting portion 38 among the plurality of connecting portions 38 is connected to the coil portion 34F and is connected to a power supply terminal (not shown). Although not shown, another connecting portion 38 among the plurality of connecting portions 38 is electrically connected to the coil portion 34A and is electrically connected to another connecting portion 37 among the plurality of connecting portions 37 connected to the coil portion 33B. In a similar manner, the coil portion 34B, the coil portion 34C, the coil portion 34D, and the coil portion 34E are electrically connected to the coil portion 33C, the coil portion 33D, the coil portion 33E, and the coil portion 33F, respectively, by the connecting portions 37 and the connecting portions 38.

The printed wiring board 20 includes a base film 40, a wire 41, and a wire 42. The base film 40 has a main surface 40a and a main surface 40b. The main surface 40b is a surface opposite to the main surface 40a. The main surface 40a and the main surface 40b are end surfaces of the base film 40 in a thickness direction. The base film 40 is formed of an electrically insulating material having flexibility. The base film 40 is formed of, for example, polyimide.

The wire 41 is disposed on the main surface 40a. The wire 41 includes a plurality of coil portions 43. The plurality of coil portions 43 are arranged in an annular shape in plan view. In the example shown, the wire 41 includes six coil portions 43. These six coil portions 43 are respectively referred to as a coil portion 43A, a coil portion 43B, a coil portion 43C, a coil portion 43D, a coil portion 43E, and a coil portion 43F. The coil portion 43A, the coil portion 43B, the coil portion 43C, the coil portion 43D, the coil portion 43E, and the coil portion 43F are arranged in this order in the clockwise direction when viewed from the main surface 40a side. The coil portions 43 are each formed by winding the wire 41 spirally in plan view. A winding direction of the wire 41 in one of two adjacent coil portions 43 is opposite to a winding direction of the wire 41 in the other of the two adjacent coil portions 43.

Each of the coil portions 43 includes a first portion 43a, a second portion 43b, a third portion 43c, and a fourth portion 43d. The first portion 43a and the second portion 43b each extend along the circumferential direction DR1 in plan view, and are spaced apart from each other along the radial direction DR2 in plan view. The third portion 43c and the fourth portion 43d each extend along the radial direction DR2 in plan view, and are spaced apart from each other along the circumferential direction DR1 in plan view.

The wire 42 is disposed on the main surface 40b. The wire 42 includes a plurality of coil portions 44. The plurality of coil portions 44 are arranged in an annular shape along the circumferential direction in plan view. In the example shown, the wire 42 includes six coil portions 44. These six coil portions 44 are respectively referred to as a coil portion 44A, a coil portion 44B, a coil portion 44C, a coil portion 44D, a coil portion 44E, and a coil portion 44F. The coil portion 44A, the coil portion 44B, the coil portion 44C, the coil portion 44D, the coil portion 44E, and the coil portion 44F are arranged in this order in the counterclockwise direction when viewed from the main surface 40b side.

The coil portions 44 are each formed by winding the wire 42 spirally in plan view. A winding direction of the wire 42 in one of two adjacent coil portions 44 is opposite to a winding direction of the wire 42 in the other of the two adjacent coil portions 44. Each of the coil portions 44 includes a first portion 44a and a second portion 44b that each extend along the circumferential direction DR1 in plan view and are spaced apart from each other along the radial direction DR2 in plan view, and a third portion 44c and a fourth portion 44d that each extend along the radial direction DR2 in plan view and are spaced apart from each other along the circumferential direction DR1 in plan view.

The plurality of coil portions 44 overlap, in plan view, the plurality of coil portions 43 respectively. More specifically, the coil portion 44A, the coil portion 44B, the coil portion 44C, the coil portion 44D, the coil portion 44E, and the coil portion 44F overlap, in plan view, the coil portion 43A, the coil portion 43B, the coil portion 43C, the coil portion 43D, the coil portion 43E, and the coil portion 43F, respectively. Each of the plurality of coil portions 44 overlaps, in plan view, only one coil portion 43 among the plurality of coil portions 43, and does not overlap, in plan view, any other coil portions 43. In plan view, the first portion 44a and the second portion 44b overlap the first portion 43a and the second portion 43b, respectively, and the third portion 44c and the fourth portion 44d overlap the third portion 43c and the fourth portion 43d, respectively.

The wire 41 further includes a plurality of lands 45. Each of the plurality of lands 45 is connected to the innermost peripheral portion of each of the plurality of coil portions 43. The wire 42 further includes a plurality of lands 46. Each of the plurality of lands 46 is connected to the innermost peripheral portion of each of the plurality of coil portions 44. Each of the plurality of lands 46 overlaps, in plan view, a respective one of the plurality of lands 45, and is electrically connected to the respective one of the plurality of lands 45.

The wire 41 further includes a plurality of connecting portions 47. Each of the plurality of connecting portions 47 is connected to the outermost peripheral portion of each of the plurality of coil portions 43. The wire 42 further includes a plurality of connecting portions 48. Each of the plurality of connecting portions 48 is connected to the outermost peripheral portion of each of the coil portions 44.

One connecting portion 47 among the plurality of connecting portions 47 is connected to the coil portion 43A and is electrically connected to a power supply terminal (not shown). One connecting portion 48 among the plurality of connecting portions 48 is connected to the coil portion 44F and is connected to a power supply terminal (not shown). Although not shown, another connecting portion 48 among the plurality of connecting portions 48 is electrically connected to the coil portion 44A and is electrically connected to another connecting portion 47 among the plurality of connecting portions 47 connected to the coil portion 43B. In a similar manner, the coil portion 44B, the coil portion 44C, the coil portion 44D, and the coil portion 44E are electrically connected to the coil portion 43C, the coil portion 43D, the coil portion 43E, and the coil portion 43F, respectively, by the connecting portions 47 and the connecting portions 48.

The wire 31, the wire 32, the wire 41, and the wire 42 are each formed of a conductive material. The wire 31, the wire 32, the wire 41, and the wire 42 are each formed of, for example, copper or a copper alloy. The wire 31, the wire 32, the wire 41, and the wire 42 may be each formed by a semi-additive method or a subtractive method.

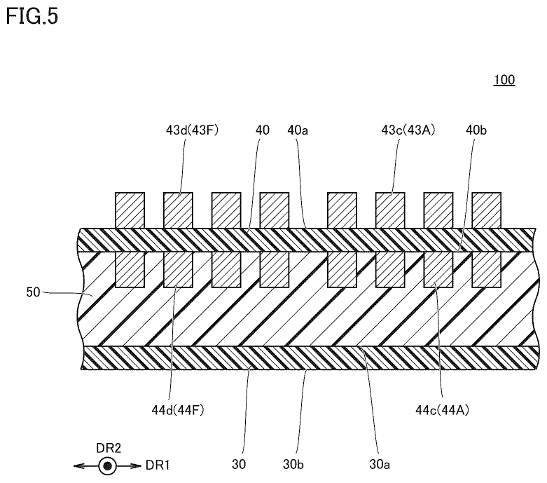

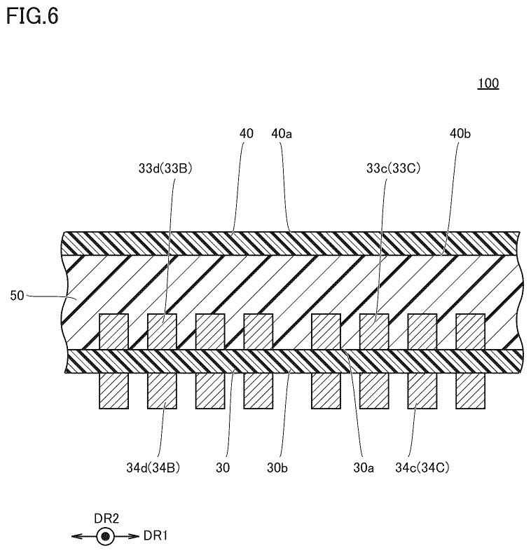

FIG. 5 is a cross-sectional view taken along line V-V in FIG. 3. FIG. 6 is a cross-sectional view taken along line VI-VI in FIG. 3. As shown in FIG. 5 and FIG. 6, the printed wiring board 20 is stacked on the printed wiring board 10 such that the main surface 40b faces the main surface 30a. The printed wiring board 20 is attached to the printed wiring board 10 with an adhesive layer 50 disposed between the main surface 30a and the main surface 40b.

As shown in FIG. 3, in plan view, a row of the coil portions 34 arranged along the circumferential direction DR1 overlaps a row of the coil portions 33 arranged along the circumferential direction DR1. The printed wiring board 20 is offset in the circumferential direction DR1 with respect to the printed wiring board 10 such that one coil portion 43 among the plurality of coil portions 43 overlaps, in plan view, both of two adjacent coil portions 33. For example, the third portion 43c of the one coil portion 43 overlaps, in plan view, the first portion 33a and the second portion 33b of one of the two adjacent coil portions 33, and the fourth portion 43d of the one coil portion 43 overlaps, in plan view, the first portion 33a and the second portion 33b of the other of the two adjacent coil portions 33.

More specifically, for example, in plan view, the third portion 43c of the coil portion 43A overlaps the first portion 33a and the second portion 33b of the coil portion 33A, and the fourth portion 43d of the coil portion 43A overlaps the first portion 33a and the second portion 33b of the coil portion 33B. This is also true for the relationship between the coil portion 43B and each of the coil portions 34B and 34C, the relationship between the coil portion 43C and each of the coil portions 34C and 34D, the relationship between the coil portion 43D and each of the coil portions 34D and 34E, the relationship between the coil portion 43E and each of the coil portions 34E and 34F, and the relationship between the coil portion 43F and each of the coil portions 34F and 34A.

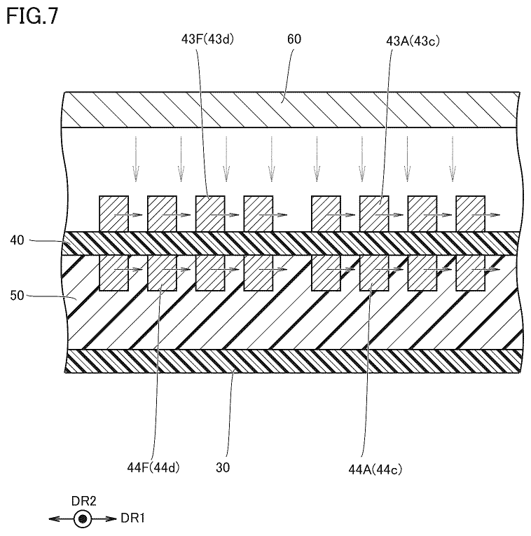

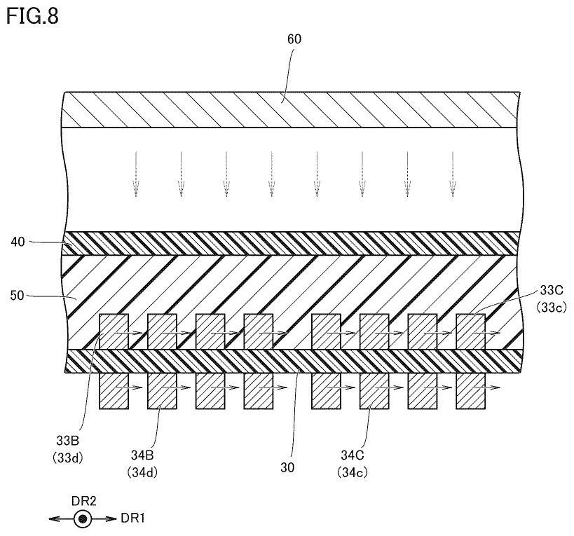

FIG. 7 is a first cross-sectional view illustrating an operation of the coil device 100. FIG. 8 is a second cross-sectional view illustrating the operation of the coil device 100. As shown in FIG. 7 and FIG. 8, an actuator using the coil device 100 includes a magnet 60. The magnet 60 generates a magnetic field (indicated by dotted line arrows in the figure) along a normal direction of the main surface 40a (main surface 40b, main surface 30a, main surface 30b). In the example shown in FIG. 7 and FIG. 8, the magnetic field is directed from top to bottom in the figure.

When the coil device 100 operates, current flows through the wire 31 and the wire 32, that is, the plurality of coil portions 33 and the plurality of coil portions 34. More specifically, in the example shown in FIG. 7 and FIG. 8, the current flows through the third portion 33c, the fourth portion 33d, the third portion 34c, the fourth portion 34d, the third portion 43c, the fourth portion 43d, the third portion 44c, and the fourth portion 44d from a back side in the plane of sheet to a front side of the paper surface in a direction perpendicular to the plane of sheet in the figure.

As a result, due to the interaction between the magnetic field and the current, thrust (indicated by a solid line arrow in the figure) is generated in the third portion 33c, the fourth portion 33d, the third portion 34c, the fourth portion 34d, the third portion 43c, the fourth portion 43d, the third portion 44c, and the fourth portion 44d in the circumferential direction DR1. Since the thrust is along the circumferential direction DR1, a torque due to the thrust causes the coil device 100 to rotate along the circumferential direction DR1, thereby functioning as an actuator.

### (Advantageous Effects of Coil Device 100)

Hereinafter, advantageous effects of the coil device 100 will be described in comparison with a coil device according to a comparative example.

In the coil device according to the comparative example, the plurality of coil portions 34 overlap, in plan view, the plurality of coil portions 33 respectively. That is, in the coil device according to the comparative example, the printed wiring board 20 is overlapped with the printed wiring board 10 without being offset in the circumferential direction DR1 with respect to the printed wiring board 10 such that one coil portion 34 among the plurality of coil portions 34 overlaps, in plan view, only one coil portion 33 among the plurality of coil portions 33. In other respects, the configuration of the coil device according to the comparative example is the same as the configuration of the coil device 100.

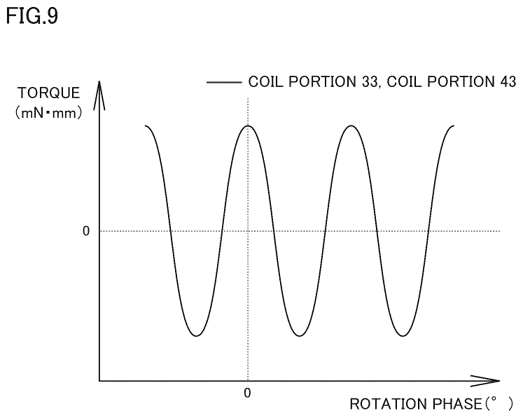

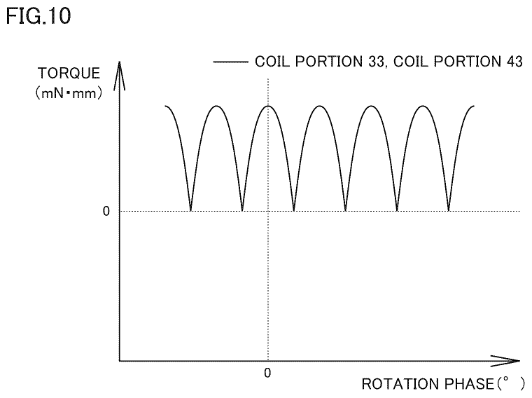

FIG. 9 is a graph showing a torque applied to the plurality of coil portions 33 and the plurality of coil portions 43 in the coil device according to the comparative example. FIG. 10 is a graph showing a torque applied to the plurality of coil portions 33 and the plurality of coil portions 43 in the coil device according to the comparative example when power supply control is performed. As shown in FIG. 9, in the coil device according to the comparative example, since the printed wiring board 20 is not offset in the circumferential direction DR1 with respect to the printed wiring board 10, a phase of the torque applied to the plurality of coil portions 33 is not shifted from a phase of the torque applied to the plurality of coil portions 43.

In addition, the torque applied to the plurality of coil portions 33 and the torque applied to the plurality of coil portions 43 fluctuate with a rotation phase of the coil device according to the comparative example. The fluctuation of the torque with the rotation phase is generated because a strong thrust is generated in coil portions where the current flows along the radial direction DR2, but no strong thrust is generated in coil portions where the current flows along the circumferential direction DR1. As a result, as shown in FIG. 10, even when power supply control is performed such that the torque applied to the plurality of coil portions 33 and the torque applied to the plurality of coil portions 43 are always positive, the torque applied to the plurality of coil portions 33 and the torque applied to the plurality of coil portions 43 greatly fluctuates with the rotation phase.

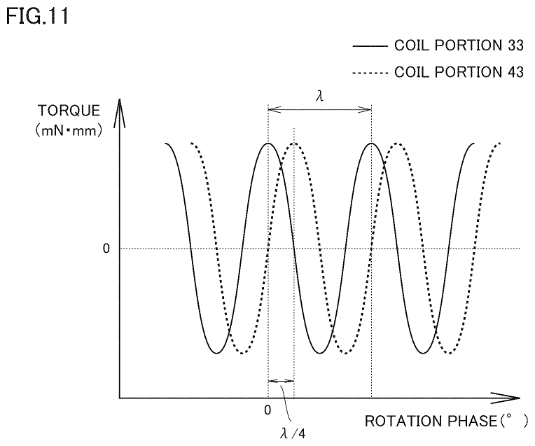

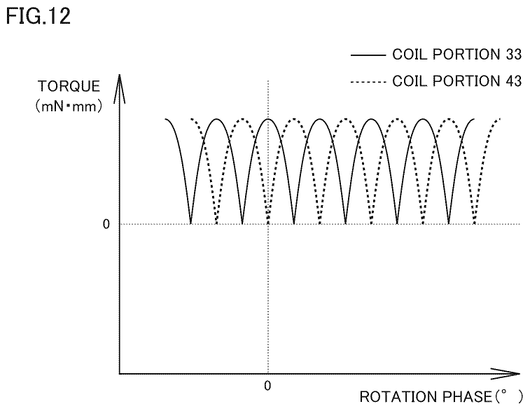

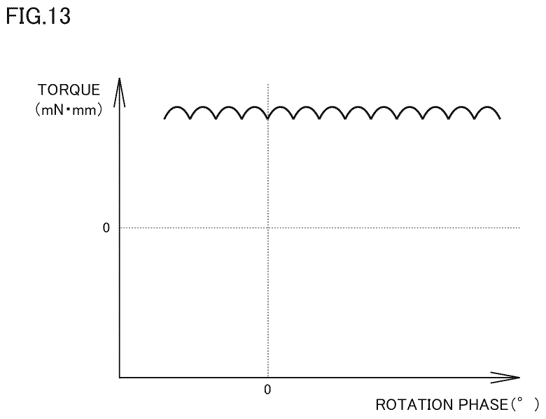

FIG. 11 is a graph showing the torque applied to the plurality of coil portions 33 and the plurality of coil portions 43 in the coil device 100. FIG. 12 is a graph showing the torque applied to the plurality of coil portions 33 and the plurality of coil portions 43 in the coil device 100 when power supply control is performed. FIG. 13 is a graph showing a resultant torque applied to the coil device 100 when the power supply control is performed. In FIG. 11 to FIG. 13, an example is shown in which the phase of the torque applied to the plurality of coil portions 43 is shifted by λ/4 with respect to the phase of the torque applied to the plurality of coil portions 33.

As described above, in the coil device 100, the printed wiring board 20 is offset in the circumferential direction DR1 with respect to the printed wiring board 10 such that the one coil portion 43 overlaps, in plan view, both of the two adjacent coil portions 33. Thus, as shown in FIG. 11, in the coil device 100, the phase of the torque applied to the plurality of coil portions 43 is shifted from the phase of the torque applied to the plurality of coil portions 33. As a result, when the power supply control is performed such that the torque applied to the plurality of coil portions 33 and the torque applied to the plurality of coil portions 43 are always positive, one peak of the phase of the torque applied to the plurality of coil portions 43 is positioned between two adjacent peaks of the phase of the torque applied to the plurality of coil portions 33, thereby reducing the fluctuation of the resultant torque applied to the coil device 100 with the rotation phase.

From another viewpoint, in the coil device 100, the portions of the coil portions 43 (coil portions 44) to which a strong thrust is applied overlap the portions of the coil portions 33 (coil portions 34) to which no strong thrust is applied, and the portions of the coil portions 33 (coil portions 34) to which a strong thrust is applied overlap the portions of the coil portions 43 (coil portions 44) to which no strong thrust is applied, so that the fluctuation of the resultant torque applied to the coil device 100 with the rotation phase is suppressed. As described above, according to the coil device 100, the fluctuations of the torque and thrust with the rotation phase can be suppressed.

### Modification

Although the example in which the coil device 100 includes two printed wiring boards (the printed wiring board 10 and the printed wiring board 20) has been described above, the coil device 100 may include a single printed wiring board. In this case, for example, the coil device 100 does not include the printed wiring board 20, and the printed wiring board 10 includes the wire 41 on the main surface 30b instead of the wire 32. That is, in one printed wiring board, each of the plurality of coil portions included in a wire disposed on one main surface of the base film 30 may be offset in the circumferential direction DR1 so as to overlap two adjacent coil portions among the plurality of coil portions included in a wire disposed on the other main surface of the base film 30.

It should be understood that the embodiments disclosed herein are merely illustrative and non-restrictive in all respects. The scope of the present disclosure is defined by the claims rather than the embodiments described above, and is intended to include all modifications within the scope and meaning equivalent to the claims.

What is claimed is:

1. A coil device comprising:
a first printed wiring board; and
a second printed wiring board,
wherein the first printed wiring board includes a first base film having a first main surface, and a first wire disposed on the first main surface,
wherein the first wire includes a plurality of first coil portions each formed by winding the first wire spirally in plan view, the plurality of first coil portions being arranged along a circumferential direction,
wherein the second printed wiring board includes a second base film having a second main surface and a third main surface, and a second wire disposed on the second main surface,
wherein the third main surface faces the first main surface,
wherein the second wire includes a plurality of second coil portions each formed by winding the second wire spirally in plan view, the plurality of second coil portions being arranged along the circumferential direction, and
wherein the second printed wiring board is offset in the circumferential direction with respect to the first printed wiring board such that one second coil portion among the plurality of second coil portions overlaps, in plan view, two adjacent first coil portions among the plurality of first coil portions.

2. The coil device according to claim 1,
wherein each of the plurality of first coil portions includes a first portion and a second portion each extending along the circumferential direction in plan view, the first portion and the second portion being arranged along a radial direction perpendicular to the circumferential direction to be spaced apart from each other,
wherein each of the plurality of second coil portions includes a third portion and a fourth portion each extending along the radial direction in plan view, the third portion and the fourth portion being arranged along the circumferential direction to be spaced apart from each other, and
wherein the second printed wiring board is offset in the circumferential direction with respect to the first printed wiring board such that the third portion of the one second coil portion overlaps, in plan view, the first portion and the second portion of one of the two adjacent first coil portions and such that the fourth portion of the one second coil portion overlaps, in plan view, the first portion and the second portion of another one of the two adjacent first coil portions.

3. The coil device according to claim 1,
wherein the first base film has a fourth main surface,
wherein the first printed wiring board further includes a third wire disposed on the fourth main surface,
wherein the third wire includes a plurality of third coil portions each formed by winding the third wire spirally in plan view, the plurality of third coil portions being arranged along the circumferential direction,
wherein the plurality of third coil portions overlap, in plan view, the plurality of first coil portions respectively,
wherein the second printed wiring board further includes a fourth wire disposed on the third main surface,
wherein the fourth wire includes a plurality of fourth coil portions each formed by winding the fourth wire spirally in plan view, the plurality of fourth coil portions being arranged along the circumferential direction, and
wherein the plurality of fourth coil portions overlap, in plan view, the plurality of second coil portions respectively.

4. A coil device comprising:
a printed wiring board,
wherein the printed wiring board includes a base film having a first main surface and a second main surface, a first wire disposed on the first main surface, and a second wire disposed on the second main surface,
wherein the first wire includes a plurality of first coil portions each formed by winding the first wire spirally in plan view, the plurality of first coil portions being arranged along a circumferential direction,
wherein the second wire includes a plurality of second coil portions each formed by winding the second wire spirally in plan view, the plurality of second coil portions being arranged along the circumferential direction, and
wherein one second coil portion among the plurality of second coil portions is offset in the circumferential direction to overlap, in plan view, two adjacent first coil portions among the plurality of first coil portions.

5. An actuator comprising:
the coil device according to claim 1; and
a magnet configured to generate a magnetic field along a normal direction of each of the first and second main surfaces.
